(19) United States
(12) Patent Application Publication
(10) Pub. No.: US 2008/0003383 A1
(43) Pub. Date: Jan. 3, 2008

(54) REPOSITIONABLE PHOTO PAPER

(75) Inventors: Jonathan P. Kitchin, Leander, TX (US); David N. Hering, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/383,340

(22) Filed: May 15, 2006

Related U.S. Application Data
(63) Continuation-in-part of application No. 11/379,459, filed on Apr. 20, 2006.
Application No. 11/379,459 is a continuation-in-part of application No. 11/227,549, filed on Sep. 15, 2005, now abandoned.

(51) Int. Cl. B32B 33/00; B32B 9/04; B41M 5/00

(52) U.S. Cl. 428/32.18; 428/219; 428/40.1

(57) ABSTRACT

The invention pertains to a repositionable photo paper having (1) a substrate having a base sheet having opposing first and second surfaces and an image receptive coating disposed on the first surface of the base sheet; and (2) a repositionable adhesive disposed on the second surface of said base sheet. The base sheet has a minimum basis weight of about 125 g/m². In another embodiment, the base sheet has a minimum basis weight of about 125 g/m² and a maximum basis weight of about 210 g/m².

### CROSS REFERENCE TO RELATED APPLICATION

This application is a continuation in part of U.S. patent application Ser. No. 11/379,459 filed Apr. 20, 2006, which is a continuation in part of U.S. patent application Ser. No. 11/227,549 filed Sep. 15, 2005.

### FIELD OF INVENTION

This invention pertains to a repositionable photo paper. In particular, the photo paper includes a base sheet having a particular range of basis weight and a repositionable adhesive, allowing for quick and easy display of photos.

### BACKGROUND

The use of digital cameras has increased in recent years. For example, in digital photography, the consumer can capture the desired images using the digital camera, view the images (now pictures) almost instantaneously on the camera screen, and at a later time select which image, if any, should be printed on photo paper for display and viewing. Thus with digital photography, the photographer has the ability to select the most desirable images from a repertoire of stored images. In contrast, in traditional photography, most consumers take photos of the intended image, which is captured on the camera film. The exposed film is taken to a photo-processing lab, which in turn generates a hard copy of the photographs. Because there is no ability to preview the photos, the consumer would receive all the pictures and consequently pay for all the pictures, whether the picture was desired or not.

There are a whole host of commercially available digital camera manufacturers, such as Canon, Sony Corporation, and Nikon Corporation, to name a few. One advantage of digital images is that they can be saved and stored in the camera's processor and later sent to a digital printer to generate a hard copy of the image for display, archiving, scrapbooking, and similar activities. Like the digital cameras, there are many commercially available photo papers that a consumer can use to generate a hard copy of the image. Hewlett Packard, e.g., offers a variety of matte, semi-gloss, or glossy photo paper. Some of these photo papers can be used for archival purposes, if desired.

The company Hemmi Papilio Supplies (HPS) LLC in Rhome, Tex. supplies what is described as an inkjet high glossy adhesive photo paper. The paper is “self adhesive” and said to be suitable for all inkjet printers including Epson Durabrite™ printer. From the product catalog available as of the filing date of this application, this product (designation PGA8511) has a thickness of 0.008 inch and a liner of 0.0025 inch. The same company also offers a satin gloss photo paper, also described as self adhesive, where the adhesive is permanent, under product designation SGA8511. The satin paper has a thickness of 8 mils on a 90# stay flat liner. Both products have a photo paper that is fully coated with adhesive on one side, the adhesive protected by a liner. One possible disadvantage of fully adhesive coated paper is that upon removal of the paper from the display surface, the paper and the photo imaged thereon may be destroyed because the paper curls and creases. Furthermore, removal of a fully backed adhesive paper from a substrate can be difficult, because like a piece of tape or a label, one must start peeling from an edge or a corner of the paper to begin lifting it off the substrate.

The company AERO Komerciala, Celje, Slovenija, whose website as of the filing date of this application is wWW.aero.si, offers a Tix® Tape Mega Memo, which has been described in Aero's product literature as an A4 size paper (about 21 cm by 30 cm) having a removable adhesive stripes coated along the shorter edges, protected with two siliconized liner strips, each about 4 cm wide by 21 cm long. One possible disadvantage of having such a construction is that upon stacking the paper in a paper tray of the printer, because of the two liners at the edges, the paper will stack with uneven thickness, i.e. higher at the ends than in the middle of the stack. This uneven thickness in stacking may result in poor paper feed reliability as the paper travels through the printer.

With the availability of digital cameras and with the advent of various digital printers, on demand printing has become commonplace behavior. There are consumers who prefer the ability to print the digital photos at their leisure. There is also a need for quality, economically priced, photo paper. There is also a need for photo paper where a liner, if used, is ease to remove and the paper can be repositioned on a substrate without damaging the photo.

### SUMMARY

The present invention relates to a photo paper that is intended as a consumable product. The photo paper includes a substrate, a repositionable adhesive, and a liner to allow for easy one-step, print to display of the image. With the infrastructure available for creating, electronically saving, and printing digital photos, the inventive photo paper is especially useful for generating and displaying the digital photos. Once done with displaying the photo, the consumer can but does not need to archive the photo. In this way, photos can be updated on a regular basis and the photos can be displayed quickly without the need to use frame or alternative hardware. Photos can also be displayed on any horizontal or vertical surface that the repositionable adhesive can be adhered to, such as, e.g., refrigerators (without the need for using magnets), wood or plastic surfaces (without the need for using additional tape), fabrics, walls, and windows. The repositionable adhesive is selected to provide good adhesion to the intended surface and yet will not leave residue adhesive once the photo paper has been removed.

Advantageously, the inventive photo paper is economically priced compared to those that are commercially available today and with the feature of ease of display, the consumer has immense flexibility in displaying the number of photos and in selecting the location for display.

In one aspect, the present invention pertains to a repositionable photo paper comprising (1) a substrate comprising a base sheet having opposing first and second surfaces and an image receptive coating disposed on the first surface of the base sheet; and (2) a repositionable adhesive disposed on the second surface of the base sheet; wherein said base sheet has a minimum basis weight of about 125 g/m².

In another aspect, the present invention pertains to a repositionable photo paper comprising (1) a substrate comprising a base sheet having opposing first and second surfaces and an image receptive coating disposed on the first surface of the base sheet; and (2) a repositionable adhesive disposed on the second surface of the base sheet; wherein the base sheet has a minimum basis weight of about 125 g/m² and a maximum basis weight of about 210 g/m².

In another aspect, the present invention relates to a method of making a repositionable poster. The method comprises the steps of: (1) providing a digital image, (2) providing a central processing unit (CPU) including photo handling software, the CPU capable of receiving bit mapped images; (3) providing an electrophotographic printer that is in communication with the CPU; (4) providing a repositionable paper comprising a substrate comprising a base sheet having opposing first and second surfaces and an electrographic image receptive coating disposed on said first surface of said base sheet; and a repositionable adhesive disposed on said second surface of said base sheet; wherein said base sheet has a minimum basis weight of about 125 gram/m²; (5) using the photo handling software to create a virtual image of the photo, and (6) printing the virtual image onto the repositionable photo paper.

When an individual consumer wants to create a photo from a digital image, the following illustrative method can be used. Typically, the consumer would have access to a central processing unit (CPU), such as a computer, that includes photo handling software. The software is capable of receiving bit mapped images, e.g. digital photo stored in the CPU's memory. The digital photo could be received via electronic mail, downloaded from an internet web site, or uploaded from a memory source (e.g., a flash card or a compact disc) just to name a few exemplary sources. The consumer also has access to a photo printer (typically a desktop printer), which is in communication with the CPU. The consumer loads the repositionable photo paper of the present invention into the photo printer, retrieves a desired bit mapped images and creates a virtual image of the photo on the CPU's screen in order to preview the photo, and using the software, prints the bit mapped image onto the repositionable paper.

In this document, the term “about” is presumed to modify all numerical values.

### BRIEF DESCRIPTION OF THE DRAWINGS

The invention can be better understood with reference to the following drawings, wherein:

FIG. 1 is an isometric view of an exemplary embodiment of the present invention;

FIGS. 2a and 2b are plan views of the second surface of the base sheet of various exemplary embodiments of the present invention;

FIG. 3 is a plan view of the backside of another exemplary embodiment of the present invention with a liner partially removed; and

FIG. 3a is a cross sectional view of the embodiment of FIG. 3.

These figures are idealized, are not drawn to scale, and are intended merely for illustrative purposes.

### DETAILED DESCRIPTION

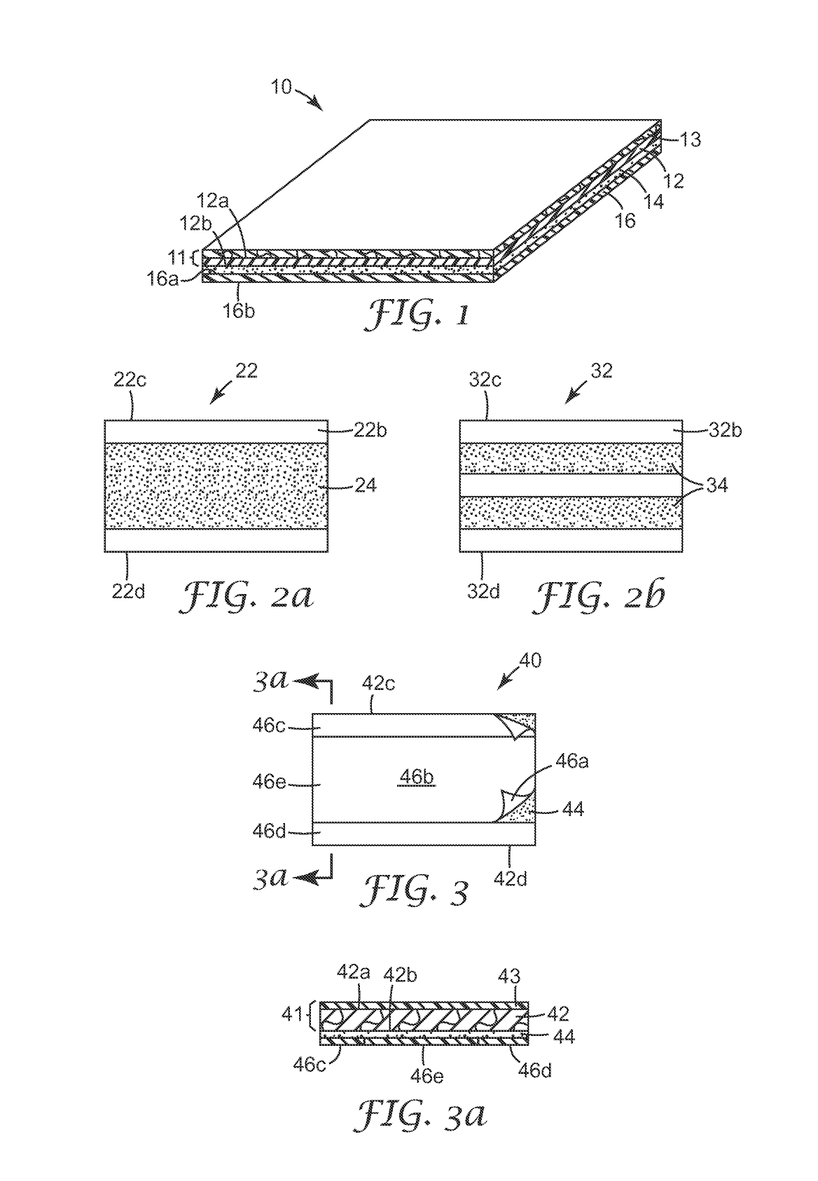

FIG. 1 shows one exemplary embodiment of the present invention. Repositionable photo paper 10 includes substrate 11. The substrate includes base sheet 12 having opposing first and second surfaces 12a and 12b respectively and image receptive coating 13 disposed on first surface 12a of the base sheet. Repositionable adhesive 14 is disposed on the second surface 12b of the base sheet. In this particular embodiment, the repositionable adhesive covers substantially all of the second surface of the paper. The image receptive coating covers substantially all of the first surface of the paper. Disposed on the repositionable adhesive is liner 16, such that its first surface 16a is in direct contact with the repositionable adhesive. In alternate embodiments, discussed below, where the repositionable adhesive is not coextensive with the second surface of the base sheet, the liner would be in direct contact with the repositionable adhesive and portions of the second surface of the base sheet.

FIGS. 2a and 2b are plan views of the backside of the base sheet 22 and 32 respectively where the repositionable adhesive is not coextensive with the second surface 22b and 32b of the base sheet. In FIG. 2a, the repositionable adhesive is in the form of a stripe that covers a major surface area of second surface 22b with the stripe spaced from and substantially parallel to edges 22c and 22d of the base sheet. In another embodiment, the repositionable adhesive strip covers almost the entire second surface of but not to the edge of the base sheet. In FIG. 2b, two stripes of repositionable adhesive 34 are shown, each stripe spaced apart from one another and from edges 32c and 32d, and disposed substantially parallel to the edges. The surface area coverage of the repositionable adhesive depends on several factors, such as, but not limited to, the tackiness or aggressiveness of the adhesive selected for use, the coating weight and or coating thickness of the adhesive, and the size of the base sheet.

FIG. 3 shows a plan view of the backside of repositionable photo paper 40 with liner 46 having opposing first and second surfaces, 46a and 46b, and precut segments. Two outer segments 46c and 46d, each proximate to edges 42c and 42d of the base sheet, sandwich inner segment 46e. In this particular embodiment, the outer segments are narrower than the inner segment. FIG. 3a shows a portion of the outer segment 46c and inner segment 46e peeled back to expose repositionable adhesive 44. The precut segments allow for easy removal of the liner, especially when the repositionable adhesive covers substantially all of the second surface of the base sheet. In use, once the photo paper is imaged, a consumer could peel back inner segment 46e and display the photo while leaving the two outer liner segments. This mode of display allows for easy removal of the photo, as the edges of the repositionable photo paper have not been adhesively attached to the substrate. Alternatively, the consumer could remove one or both of the outer segments and take advantage of the entire surface area of the second surface of the base sheet, which has been substantially fully coated with the repositionable adhesive. If desired, second surface 46b of the liner could contain indicia or graphics.

FIG. 3a is a cross-sectional view of the embodiment of FIG. 3 taken along line 3a-3a. The repositionable photo paper includes imageable substrate 41 having base sheet 42 and image receptive coating 43 disposed on first surface 42a of the base sheet. On second surface 42b of the base sheet is disposed repositionable adhesive 44. Liner 46 protects the adhesive until use. The liner has outer precut sections 46c and 46d and inner precut section 46e sandwiched therebetween.

In one embodiment, the base sheet of the present invention has a minimum basis weight of 125 g/m². As used herein, the term basis weight is equivalent to its grammage and can be reported in units of grams per square meter (g/m²) or pounds per unit area, such as, e.g., pounds per 1300 ft². The basis weight of the base sheet is the weight at the end of the paper making process and does not include any image receptive coating that may have been coated on the base sheet in a separate coating operation. In another embodiment, the base sheet of the present invention has a minimum basis weight of 125 g/m² and a maximum basis weight of 210 g/m². Commercially available base sheet are available from suppliers such as International Paper, Schoeller, and Domtar, Inc., to name a few.

In one embodiment, the base sheet has a minimum thickness of 0.006 inch (0.15 mm). In another embodiment, the base sheet has a minimum thickness of 0.006 inch and a maximum thickness of 0.009 inch (0.23 mm). While the basis weight of the base sheet can be an indicator for its thickness, the thickness can also be measured using a conventional caliper, typically after the base sheet has been conditioned in a controlled environment after a period of time. For example, it is acceptable industry practice to condition the base sheet in a constant humidity temperature room, such as one that is set at 20° C., 50% relative humidity, for 24 hours.

Most inkjet printers have an upper limit on the thickness of the substrate that it will accept. Typically the upper thickness limit is in the range of 0.012 to 0.015 inch (0.30 to 0.38 mm). Thicker substrates will most likely face flexibility issues, as it must bend around the various mechanical rollers inside the printer. The repositionable photo paper of the present invention contains a multilayer construction where the base sheet and the liner contribute most of the thickness. The liner has a typical thickness of 0.002 to 0.004 inch (0.05 to 0.10 mm). It has been found that at the upper of limit of 210 g/m² or at the upper limit of 0.009 inch in thickness, the base sheet with the liner approaches the upper limit of most inkjet printers. There is an economic value of using thinner base sheets or of a lower basis weight than the upper limit, as the cost of the base sheet is reduced. Also, it has been found at lower limit of 125 g/m² or at the lower limit of 0.006 inch in thickness, the base sheet has feel more like conventional photo paper. At less than the minimum values, the base sheet tends to be too thin to have the feel of conventional photo paper. By “conventional photo paper” it is meant photo paper supplied by companies such as, e.g., Kodak and Fuji, that use a chemical process, a silver halide chemical process, to produce photographs. Thus, the minimum and maximum values of basis weight and thickness recited herein provide an advantageous range for the repositionable photo paper of the present invention.

The image receptive coating covers the first side of the base sheet. The image receptive coating can be of any composition that adheres to the substrate and is suitable for digital printing, such as inkjet printing, color inkjet printing, laser printing, and dye or mass transfer printing. When the image receptive coating is an inkjet receptive coating, suitable coatings would include two general classes of compositions: (1) those that absorb ink by capillary action, commonly described as porous, microporous, or nanoporous coatings, which may include silica, mixed oxides, and hydroxides of aluminum, and (2) those that include a hydrophilic polymer that absorbs ink by swelling, which are commonly referred to as swellable polymer coatings.

Suitable porous, microporous, or nanoporous coatings include U.S. Pat. Nos. 6,502,935 (Barcock et al.) and 6,830,798 (Misuda et al.).

Suitable swellable polymer, ink receptive coatings are described in U.S. Pat. No. 5,134,198 (Stofko, Jr. et al.), and 5,389,723 (Iqbal et al.). In very brief summary, both patents describe semi-interpenetrating polymer networks. These networks are blends of polymers where at least one of the polymeric components is crosslinked after blending to form a continuous network throughout the bulk material, and through which the uncrosslinked polymeric components are intertwined in such a way as to form a macroscopically homogeneous composition. Another suitable image receptive coating is described in U.S. Pat. No. 6,806,310 (Kopolow et al.), which discloses copolymers of dimethylaminopropyl methacrylamide (DMAPMA) and hydroxyethyl methacrylate (HEMA). It is stated that substrates coated with these copolymers are capable of absorbing the solvents, e.g., water or organic solvents, of digital printing inks rapidly with dry times of less than one minute. Yet another suitable image receptive coating is described in US Patent Application Publication No. US 2005/0027068, which discloses terpolymer compositions of vinyl caprolactam, DMAPMA, and HEMA to coat substrates for use in computer printers. Yet another useful ink receptive coating composition is disclosed in U.S. patent application Ser. No. 11/280,845 filed on Nov. 15, 2005.

In addition to generating digital photographs using a desktop inkjet photo printer, it is becoming increasingly common for consumers of digital photography to have their pictures printed using commercial retailers. For example, from a computer the consumer may upload digital picture files to an internet-based photo hosting website. These hosting websites allow consumers to store and organize their digital pictures. The websites also provide the service of making the digital pictures available for others related to the consumer, such as family and friends. The photo hosting websites can further provide a service whereby anyone who has permission to view a photograph that has been posted to the site can order a printed copy of the photograph. The printed copy may either be delivered by mail to a recipient's designated location or, in some cases, it may be sent to a nearby retail store that is designated by the recipient. Alternatively consumers may take a memory storage media (e.g., a flashcard) from their digital cameras to a photo kiosk or photo computer terminal at a retail photo processing store and order printed copies of selected digital photographs. In this particular case, the photographs may either be printed at the store or printed in a remote central location that supplies prints to multiple stores.

The commercial printing operations offer a benefit of providing a wider selection of print sizes than is typically available from the desktop inkjet photo printer. For example, poster size prints are commonly available from commercial printers in sizes of 12 by 18 inches or larger. The present invention is particularly advantageous in the case of poster-sized prints because they are specifically intended for display on the wall of a home or office. The inventive repositionable photo paper can be removed multiple times without damaging the wall and without substantially curling the photo or leaving adhesive residue, which makes it especially useful in the case of poster sized digital prints.

Commercial printing operations can use inkjet printers to apply digital images to the repositionable photo paper of the current invention. For reasons of printing cost and speed, however, it may be advantageous to use an electrophotographic imaging process. Electrophotographic printers are available from companies such as Hewlett Packard. Such printers include dry toner based printers (commonly referred to as “laser printers” or “color laser printers”) and liquid toner based printers (sometimes referred to as “digital presses”). For example, Hewlett Packard has its INDIGO brand digital presses.

In electrophotographic printing, the image is formed by electrostatic attraction between the toner particles and a pattern of electrostatic charge on a photoconductor drum. The electrostatic charge is produced by action of light on a charged photoconductor. A final full color image is built up on the drum (or belt) by sequential addition of yellow, magenta, cyan and black toner components (not necessarily in that order). The toner image is then transferred to a paper (typically referred to as “paper stock”) and fixed in place by a combination of heat and pressure.

The image receptive coating used in the repositionable photo paper of the present invention may be adapted to receive electrophotographic images. Electrophotographic image receptive coatings suitable for high quality photo paper applications are well known in the art. Typical coatings are composed primarily of inorganic silicates such as natural mineral clays and or calcium carbonate together with sufficient amount of organic polymer (such as styrene butadiene latex) to bind the coating together and confer mechanical strength and flexibility. Electrolytes or other electrically conductive materials may be added to the coating to control electrical conductivity.

In one exemplary method of making a repositionable poster, the following steps can be used. A CPU, loaded with photo handling software, is in communication with an electrophotographic printer containing repositionable photo paper of the present invention. The software is capable of receiving bit mapped images, e.g. digital photo stored in the CPU's memory. The digital photo could be received via electronic mail, downloaded from an internet web site, or uploaded from a memory source (e.g., a flash card or a compact disc). An individual uploads a bit mapped image onto the CPU and using the software instructs the printer to print and thereby produce the repositionable poster, now containing the desired image.

The repositionable adhesive covers the second side of the base sheet. One suitable repositionable adhesive is a microsphere adhesive. An exemplary microsphere adhesive includes polyacrylic derivatives. The repositionable adhesive can be solvent based, water based, or can be a solventless, hot melt adhesive. Suitable repositionable adhesives includes those disclosed in the following U.S. Pat. Nos. 3,691,140 (Silver); 3,857,731 (Merrill et al.); 4,166,152 (Baker et al.); 4,495,318 (Howard); 5,045,569 (Delagado); 5,073,457 (Blackwell) and 5,571,617 (Cooprider et al.), 5,663,241 (Takamatsu et al.); 5,714,237 (Cooprider et al.); US RE 37,563 (Cooprider et al.); and U.S. Pat. Nos. 5,756,625 (Crandall et al.) and 5,824,748 (Kesti et al.).

The repositionable photo paper of the present invention can be further characterized by two adhesion tests: (1) adhesion to polyester (specifically polyethylene terephthalate), and (2) static angle test (SAT). Both are described below in detail.

The adhesion to polyester test is performed by laminating a 1.25 inch (32 mm) strip of plain polyester, product designation OR16 film from 3M Company, St. Paul, Minn., over the previously coated and dried sample of repositionable adhesive. The polyester is laminated to the adhesive by using a 2 kg rubber coated roller rolling at a rate of 12 inch/min (25.4 mm/min). Using a stress/strain gauge, such as one available from Instron Corp., the polyester film is pulled away from the adhesive at a 90° angle at a peel rate of 12 inch/min (305 mm/min). The peel force is recorded in grams/inch.

The SAT measures the ability of the photo media with its repositionable pressure sensitive adhesive to remain adhered on a standard test panel while being subjected to removal pressure at a specified peel angle under a constant load. The static angle test is one quantitative procedure for measuring detachment resistance of the photo media.

In performing static angle test, six photo media samples can be prepared using the following exemplary process. The samples are all the same size, 33 mm wide by 76 mm long. Each sample of photo media includes an adhesive stripe that is 18 mm wide by 33 mm long, where the long dimension of each adhesive stripe is positioned along the short dimension of, and at the top of, each photo media sample.

The test panel is a steel panel with a painted surface. Each sample is applied to the painted steel panel with the long dimension of the adhesive stripe horizontally oriented and located at the top of the photo media sample. Then, the sample is pressure adhered to the painted steel surface by two passes of an application roller with an application pressure of 1.5 pounds per square inch (77.6 mm of mercury).

The mounted sample is placed in a holder frame that is vertically oriented approximately perpendicular to a ground surface. The painted steel panel is held at a 30° downward angle relative to the vertically oriented frame. A 100 gram load is applied to the lower end of the photo media sample, proximate to the lower end of the holder frame. A timer is started upon application of the 100 gram load to measure how long the sample remains attached to the painted steel surface before the photo media sample detaches from the steel panel. The SAT usually runs to failure, i.e., until the sample actually detaches form the steel panel. The time to detachment is usually measured in seconds as the average of six results.

The photo media of the present invention has an adhesion to polyester value of 200 gram/inch (7.9 gram/mm) or less, preferably less than 160 gram/inch (6.3 gram/mm) or less, and a SAT value of 600 seconds or greater, preferably 1800 seconds or greater. The lower the adhesion to polyester value, the easier it will be to remove the photo media from the substrate to which it has been attached. The higher the SAT value, the more likely the photo media will remain adhered to the intended substrate once it has been applied.

The liner covers and protects the repositionable adhesive and the substrate until it is imaged and ready for display. The liner can be any paper or plastic sheet that bonds to the repositionable adhesive securely during storage and while passing through the feed mechanism of a printer. The liner releases cleanly and easily from the repositionable adhesive after the photo paper has been imaged. The liner may be treated with a release coating to achieve the desired release performance. The release coating would be disposed on the first surface of the liner such that it would be disposed on the repositionable adhesive. Suitable coatings include those that based on straight chain alkane derivatives, polydialkyl siloxane derivatives, or fluorocarbon derivatives. One exemplary release coating is described in U.S. Pat. No. 5,032,460 (Kanter et al.). The release coating will be applied on the liner, typically the entire surface area of the liner, to reach a dry coating weight of from 0.05 to 0.1 g/ft² (0.54 to 1.1 g/m²). Suitable silicone-based release liners are commercially available from Loparex, Inc., Willowbrook, Ill.

In one exemplary process, the inventive photo paper is made in a continuous process as follows. A base sheet, typically in jumbo form, is provided. The image receptive coating is coated on the first side of the base sheet using coating or printing processes. The coated base sheet passes through a first drying unit, such as an oven. At a next station, to the second side of the base, the repositionable adhesive is applied in a desired pattern using coating or printing processes. Optionally, an additional primer coating may be interposed between the adhesive and the base sheet. The adhesive coated base sheet, whether or not primed, passes through a second drying unit. A liner is then laminated to the base sheet such that the liner contacts the repositionable adhesive and the second side of the base sheet. The liner can be scored to create precut segments as shown in FIGS. 3 and 3a.

It has been further found that in the printing process used to produce the photo paper of the present invention, paper with a basis weight of greater than 210 g/m² is harder to handle around the various mechanical equipments than paper having a basis weight less than 210 g/m² because of the weight and of the thickness of the paper.

The photo paper can be wound into roll form and or converted into the desired size. Illustrative sizes include, but are not limited to, 4×6 inch, 5×7 inch, 8½×11 inch, and A4 size paper. The dry coating thicknesses of the image receptive coating and the repositionable adhesive should be sufficient to provide the desired product attributes, including features such as good print quality (good resolution of the image) and good bonding to a surface. In one embodiment, the dry coating thickness of the image receptive coating is greater than 3 microns and less than 30 microns.

Although specific embodiments of the present invention have been shown and described, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

All US Patents, published patent applications, and patent applications cited herein are incorporated by reference in their entirety.

What is claimed is:

1. A repositionable photo paper comprising:
a substrate comprising a base sheet having opposing first and second surfaces and an image receptive coating disposed on said first surface of said base sheet; and
a repositionable adhesive disposed on said second surface of said base sheet;
wherein said base sheet has a minimum basis weight of about 125 gram/m².

2. The repositionable photo paper of claim 1, wherein said base sheet has a maximum basis weight of about 210 gram/m².

3. The repositionable photo paper of claim 1, wherein said repositionable adhesive is a microsphere adhesive.

4. The repositionable photo paper of claim 4, wherein said microsphere adhesive comprises a polyacrylate derivative.

5. The repositionable photo paper of claim 1, wherein said repositionable adhesive covers substantially all of said second surface of said base sheet.

6. The repositionable photo paper of claim 1 comprising at least one stripe of repositionable adhesive.

7. The repositionable photo paper of claim 1, further comprising a liner having opposing first and second surfaces, said first surface of said liner disposed on said repositionable adhesive.

8. The repositionable photo paper of claim 7, wherein said first surface of said liner comprises a release coating.

9. The repositionable photo paper of claim 7, wherein said liner comprises precut segments.

10. The repositionable photo paper of claim 9 comprising two outer precut segments each arranged substantially parallel and proximate to its edges, and an inner precut segment disposed between said two outer segments.

11. The repositionable photo paper of claim 10, wherein said outer precut segments are narrower than said inner precut segment.

12. The repositionable photo paper of claim 1, wherein said substrate has a minimum thickness of about 0.006 inch (0.15 mm).

13. The repositionable photo paper of claim 1, wherein said substrate has a maximum thickness of about 0.009 inch (0.23 mm).

14. The repositionable photo paper of claim 1, wherein said image receptive coating is an ink receptive coating selected from the group consisting of porous coating comprising oxides or silicates and coating of swellable hydrophilic polymer.

15. The repositionable photo paper of claim 1, wherein said image receptive coating is adapted to receive an electrophotographic image.

16. The repositionable photo paper of claim 1, wherein said substrate has a gloss value at 600 greater than about 60%.

17. The repositionable photo paper of claim 1 in precut sheet form.

18. The repositionable photo paper of claim 17, wherein said precut sheet form is selected from the group consisting of size of four by six inch, five by seven inch, eight and a half by eleven inch, and twelve by eighteen inch.

19. The repositionable photo paper of claim 1 capable of being imaged in a desktop inkjet printer.

20. The repositionable photo paper of claim 1 having adhesion to polyester of less than about 200 gram/inch and a static angle testing adhesion value greater than about 600 seconds.

21. The repositionable photo paper of claim 1 having adhesion to polyester of less than about 160 gram/inch and a static angle testing adhesion value of greater than about 1800 seconds.

22. A method of making a repositionable poster comprising the steps of:
providing a digital image;
providing a central processing unit including photo handling software, said central processing unit capable of receiving bit mapped images;
providing an electrophotographic printer that is in communication with the central processing unit;
providing a repositionable paper comprising a substrate comprising a base sheet having opposing first and second surfaces and an electrographic image receptive coating disposed on said first surface of said base sheet; and a repositionable adhesive disposed on said second surface of said base sheet; wherein said base sheet has a minimum basis weight of about 125 gram/m²;
using said photo handling software to create a virtual image of a photo; and
printing said virtual image onto said repositionable photo paper.
